(19) United States
(12) Patent Application Publication
(10) Pub. No.: US 2005/0114354 A1
(43) Pub. Date: May 26, 2005

(54) Map viewing, publishing, and provisioning system

(75) Inventors: Raj R. Singh, Cambridge, MA (US); Joshua Lieberman, Newton Upper Falls, MA (US); Adam B. Hocherman, Boston, MA (US)

Correspondence Address: FISH & RICHARDSON PC, 225 FRANKLIN ST, BOSTON, MA, 02110, US

(73) Assignee: Syncline, Inc., a Delaware corporation

(21) Appl. No.: 11/025,619

(22) Filed: Dec. 29, 2004

Related U.S. Application Data
(63) Continuation of application No. 09/755,881, filed on Jan. 5, 2001, now abandoned.

(51) Int. Cl. G06F 17/30

(52) U.S. Cl. 707/10

(57) ABSTRACT

Map information is stored centrally and used to provide web-based map viewing, publishing, and provisioning services.

### BACKGROUND

This application is a continuation of and claims the benefit of priority from U.S. application Ser. No. 09/755,881, filed Jan. 5, 2001, the disclosure of which is considered part of and is incorporated by reference in its entirety in the disclosure of this application. This invention relates to map viewing, publishing, and provisioning.

Over the past few decades, Geographic Information Systems (GIS) have migrated from mainframes, dumb terminals, and workstations running GIS software, to network-centric systems, which distribute data and computational power across multiple, dedicated servers and thin-clients.

With the advent of the Internet, GIS are rapidly adopting web tools, technologies, standards, and protocols to improve processing, distribute load, and centralize control. Web-based GIS provide universal access to data, without universal storage, and offer the advantages of easy-to-use, convenient, and highly functional web environments.

Within the past few years, GIS companies have begun building customized web-based applications for customers and hosting the applications online. To customers, the benefits of using ASPs to host GIS applications are real:
1) It reduces the Information Technology (IT) headaches customers face from support maintenance and hiring, training, and retaining staff.
2) It guarantees system performance, reliability, and security via a well-defined Service Level Agreement.
3) It allows shared access and central control of server resources, which means software upgrades and functional enhancements are easy to manage and facilitates behind-the-scenes scaling of performance and storage capacity.

### SUMMARY

In general, in one aspect, the invention features a method that includes (1) providing web-based map viewing, publishing, and provisioning services, and (2) centrally storing map information for use in providing the services.

Implementations of the invention may include one or more of the following features. Requests associated with the viewing, provisioning, or publishing of maps are received from an application server or a mapping server, and a bridging function includes reformatting the requests into non-proprietary standardized formats. The map information is stored in a database and is abstracted to generate metadata that represents the information and is accessed by a mapping application. Requests that relate to viewing, publishing, or provisioning web-based maps are served at least in part by accessing remote application service provider functions, such as locating addresses or finding shortest paths.

A user may upload map data from a client through the Internet to the server for use in executing the publishing and provisioning services. The uploaded map data is automatically integrated with the stored map information for access by remote viewers. A user at a web-client may define and build maps and spatial graphics by interaction with the server, and may categorize how web-based maps and map layers will appear based on style definitions.

Levels of security are enforced to control access by users to the viewing, publishing, and provisioning services. Access by users to the viewing, publishing, and provisioning services is managed by grouping the users according to their rights to use the respective services.

The user may:
work interactively to define the data sets, select the data files to upload, and initiate the upload,
preview a map over-the-web prior to provisioning the map,
publish a map by a single mouse click to initiate publishing at the server,
define an initial map extent using a web-based interface,
define visual attributes of a layer,
use a palette of selections for a layer element property,
define theming of map and spatial information using a web-based interface,
incorporate image data into maps using a web-based interface,
print electronic maps using a web-based interface, define and include map accessory information, and
control the layout of a map and accessory information using an interface layout panel that enables dragging and positioning of components.

Among the advantages of the invention are one or more of the following. The services provide a ready-for-use, do-it-yourself system for quickly and easily creating and providing secure and reliable web-based GIS to a wide audience. Customers don't need to pay high upfront project costs to build the application; it is already built and ready. With the ease-of-use and convenience of a web-based interface, customers are able to upload their data, publish their maps, and provision maps to their audience. MVPP combines a “one-size-fits-all” approach with powerful customization features, which allow customers to leverage the system with full control over the environment. The result, to customers, is that it appears as if their were using their own system.

Other advantages and features will become apparent from the following description and from the claims.

### DESCRIPTION

We first briefly describe the figures.

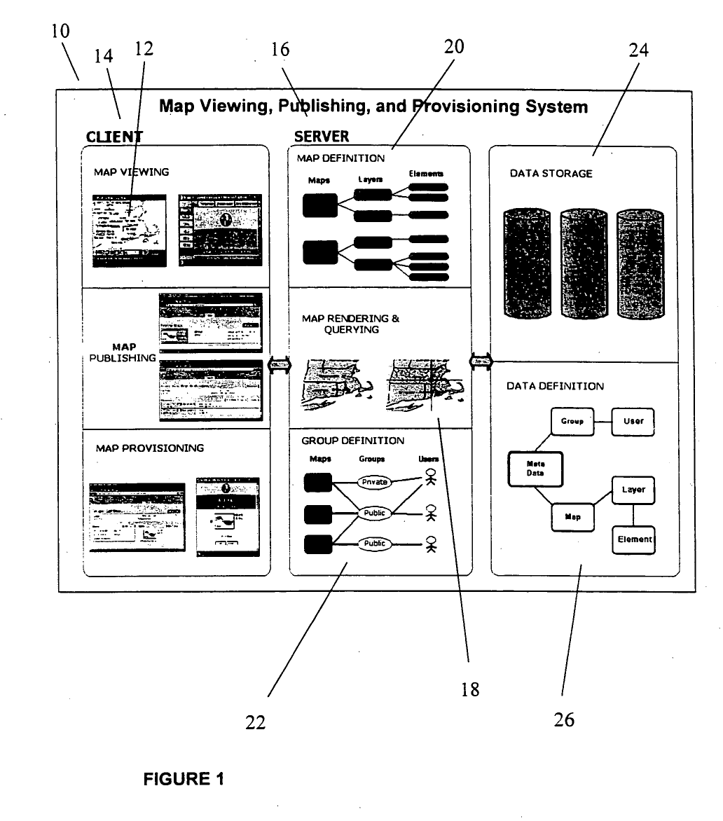

FIG. 1 shows a map viewing, publishing, and provisioning system.

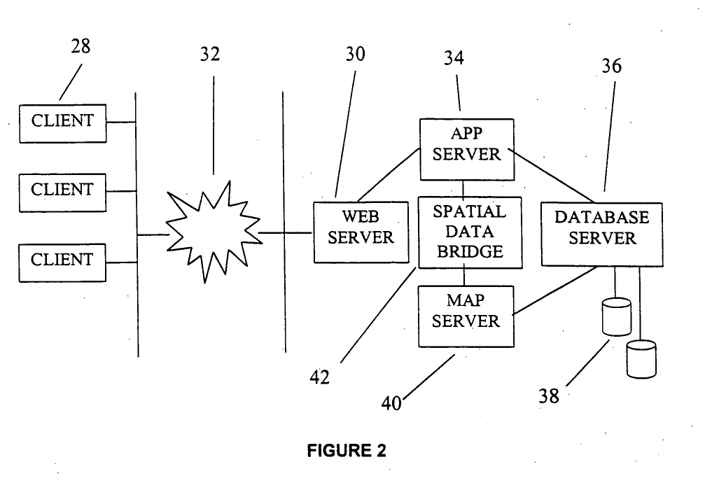

FIG. 2 shows a diagram of a system architecture.

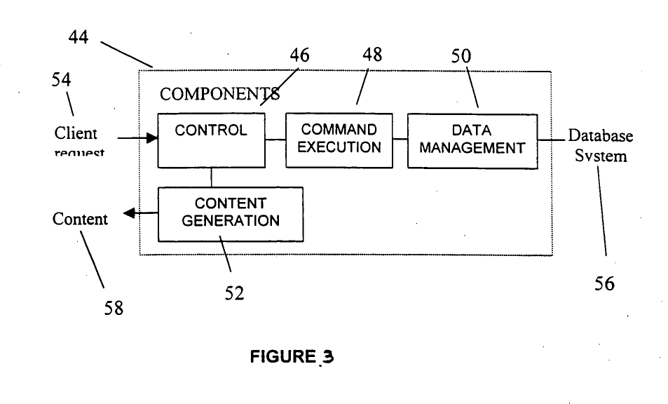

FIG. 3 shows components and flow control.

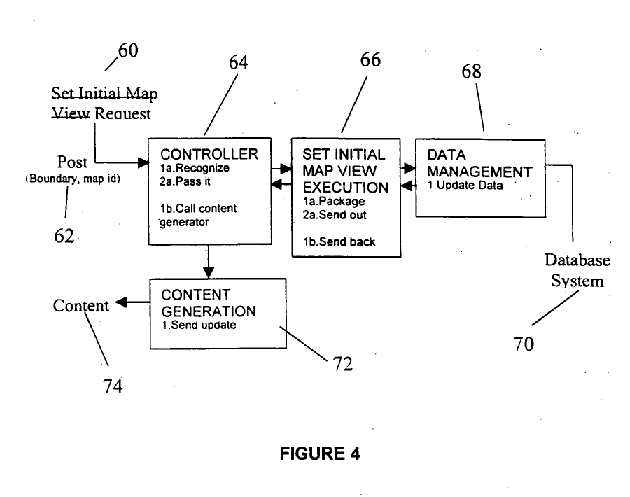

FIG. 4 shows handling of a client request.

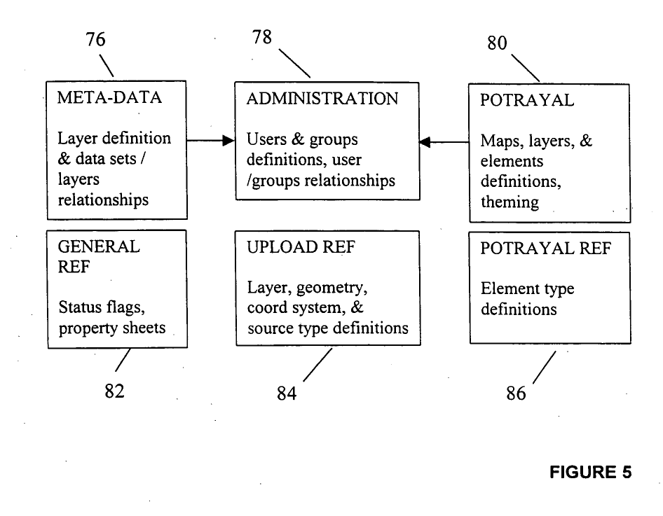

FIG. 5 shows a schema.

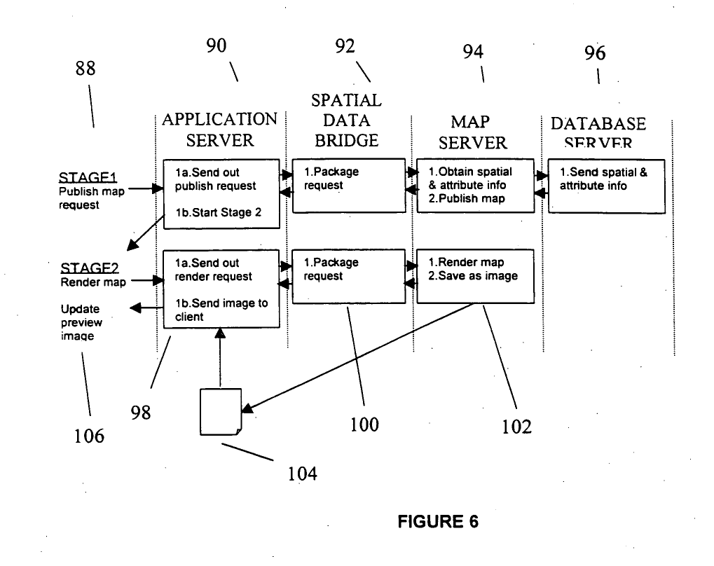

FIG. 6 shows an example of a request to publish and preview a map.

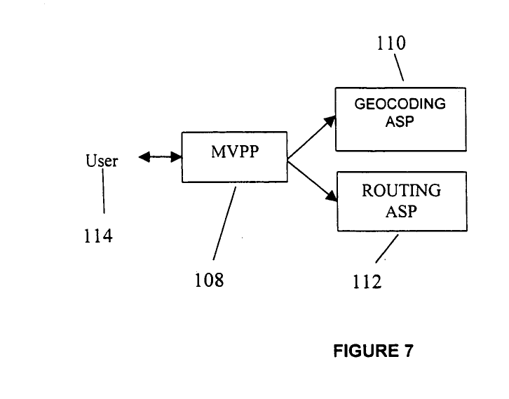

FIG. 7 shows application service provider leverage.

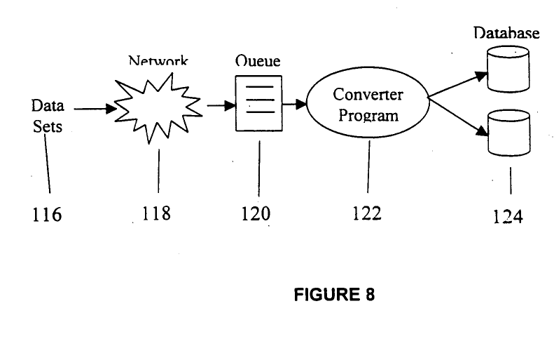

FIG. 8 shows uploading of data sets.

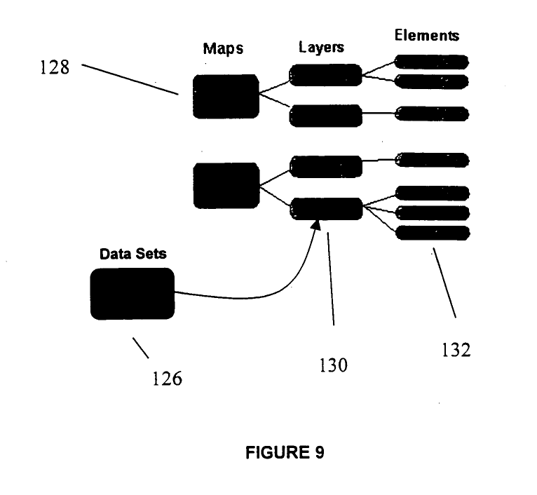

FIG. 9 shows map element relationships.

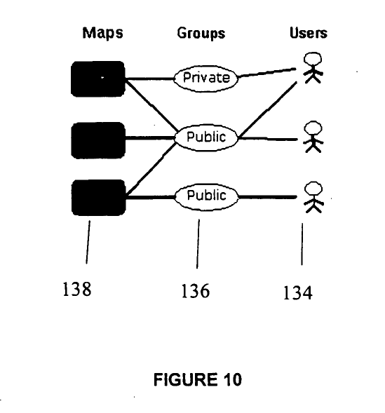

FIG. 10 shows the relationships of users, groups, and maps.

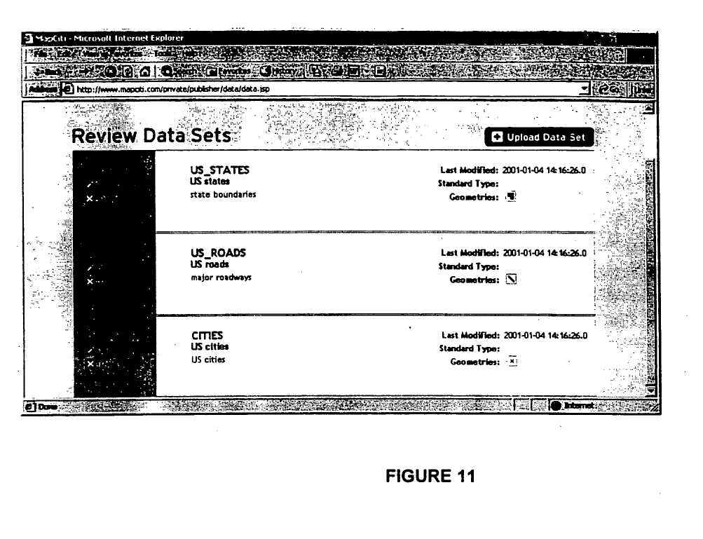

FIGS. 11, 12A, 12B, and 12C, and 13-25 are screen displays.

As shown in FIG. 1, a map viewing, publishing, and provisioning (MVPP) system 10 is a client server system for viewing, publishing, and provisioning web-based maps 12 and graphics. A user client 14 sends requests to servers 16 for map rendering and querying 18, map definition 20, map group provisioning definition 22, data storage 24, data modification definition 26, and data querying.

MVPP uses standard web tools and technologies to dynamically control and display content and information in the system. For example, Hyper-Text Markup Language (HTML), Dynamic HTML, Java Server Pages (JSP), Active Server Pages (ASP), and Cold Fusion Markup Language (CFML) may be used for client-server communications and information display. Extensible Markup Language (XML) may be used to standardize and format client-to-server and server-to-server communications. Java Servlets may be used to control, for example, application and session logic for client interaction and shared server resources.

Java may be used to, for example, enhance client-side interactivity and platform independence.

MVPP System Architecture

MVPP uses a multi-tiered approach, shown in FIG. 2, to process user requests and serve information. The requests may be in any generic format, for example an HTTP Post, and may occur between any client software 28, for example Microsoft Internet Explorer or Netscape Communicator, and any Web Server 30, for example Microsoft Internet Information Server, across the network 32. The Web Server routes the request to an Application Server 34, which communicates with a Database Server 36 to access data storage 38. The Application Server is responsible for handling session and application logic and managing multiple users and resources on the system. The Application Server reroutes Spatial Rendering and Querying (SRQ) requests to a Map Server 40 via a Spatial Data Bridge 42. The Spatial Data Bridge is a mechanism for reformatting requests between any Application Server, for example WebLogic from BEA Systems, San Jose, Calif., and any Map Server, for example, Arc Internet Mapping Server (ArcIMS) from Environmental Science Research Institute (ESRI), Redlands, Calif., into nonproprietary, standard formats, for example XML. The Spatial Data Bridge allows MVPP to employ any combination of third party software for Application and Map tiers. Other possible configurations may employ the MapGuide Platform from Autodesk, Inc., San Rafael, Calif., or MapInfo's Map Extreme Java (MXJ) from MapInfo, Inc., Troy, N.Y., for SRQ.

Application Server

The Application Server is responsible for creating and managing multiple user sessions on the system. It handles the logic behind, for example, setting up user accounts, managing groups, building and publishing maps, managing groups, and uploading spatial data to the server handling requests. The Application Server communicates with the Database Server to store, access, and modify information on the system. It also packages SRQ requests for the Map Server via the Spatial Data Bridge.

The Application Server is comprised of a series of components for application control, execution, data management, and content generation. FIG. 3 shows the components and flow of control through the system. Application logic and control components receive incoming client requests 54, routing them to command execution components 48 for processing. The command execution components process the command and, if necessary, interact with the database system via data management components 50. When the command execution component finishes, it sends results back to the control components, which then calls content generation components 52 to generate content. The content 58 is then sent back to the client to reflect the changes.

As an example, consider how the system handles a client request to set the initial map view 60 shown in FIG. 4. The client generates a post request 62 containing URL parameters defining the new map view boundaries and the map ID. A controller component 64 receives the request, recognizes it as a “set initial map view” command, and passes it to the execution component 66 responsible for processing “set initial map view” commands. The execution component packages the information and sends it to a data management component 68, which updates the map's initial view definition in the database 70. The execution component then sends the information back to the controller component, which calls a content generation component 72 to send updated content to the client. The client receives the content 74 and refreshes the view.

Database Server

The Database Server stores and manages information on, for example, user accounts, groups, published maps, uploaded data, provisioning, and spatial geometries and attributes in a relational database on user accounts, user groups, published maps, uploaded data, and spatial geometries and attributes. It is the information engine and data store for the MVPP system. The Database Server may be Oracle Spatial 8i from Oracle, Inc., Redwood Shores, Calif., SQL Server from Microsoft, Inc., Redmond, Wash., or any enterprise strength Database Server Engine.

The database represents system data in a data schema, an example of which is shown in FIG. 5, comprised of a hierarchy of table groupings for meta-data 76, administration 78, portrayal 80, general reference 82, upload reference 84, and portrayal reference 86.

The meta-data information is an abstraction of the spatial geometry and attributes in the database. MVPP uses meta-data to abstract the method of storage, for example, an Oracle database, a data file, an image file, away from the application logic to be used in a web-based mapping system. The flexible arrangement allows data, regardless of its type, to be represented and used in the system.

The portrayal information is an abstraction of the visual attributes for maps, layers, and elements, also called cartography.

The general reference, upload reference, and portrayal reference information can be represented in a generic format, for example, XML, for standardized communications between system components, servers, and clients.

The database supports object persistence, which decouples MVPP application logic, implemented in the Application Server, from data management and synchronization. The Application Server controls object persistence and allows MVPP to store the state of user interaction. MVPP is able to implement personalization for system users, which persists between sessions, regardless of shutdowns and restarts.

Map Server

The Map Server is responsible for processing SRC SRQ requests, for example, “zoom-in to twice the current scale centered at point (X,Y)” or “find the name of the object at point (X,Y)”. The Map Server receives SRQ requests from the Application Server via the Spatial Data Bridge. It communicates with the Database Server using spatial data queries to access geometry and attribute information and render the map. The Map Server sends information via the Spatial Data Bridge to the Application Server, which sends the result back to the client.

The Map Server is special software for creating two-dimensional graphics from data coordinates describing points, lines, and polygons. The coordinates reference real-world objects, for example, rivers. Map Servers use geographic or arbitrary coordinate systems to draw objects. The objects are often defined and organized in data layers, corresponding to graphical features, for example, a symbol and a point to denote the location of a city.

Geographic coordinates derive from real-world points recalculated using datums, which define the shape of the earth, and projections, which define how to project a point in space to a flat surface. Projected points are then mapped to localized map coordinates system, for example, the State of California might define a coordinate system for the northern ⅓ of the state.

Map Servers are designed to perform geographic oriented functions efficiently, for example, find the area of the State of Nevada. Navigational functions, for example, zoom-in to a subsection of the map of the US showing the State of Connecticut in its entirety, are often streamlined using spatial indexing which is able to filter drawing objects very quickly by comparing the map view extent with the object extent. For example, if the object extent does not overlap the map view extent, it isn't drawn.

Map Servers are designed to associate geometry with data attributes, for example; the State of Alabama may have data attributes data describing the population, date of statehood, etc. The relationship is leveraged to, for example, allow a user to click on graphical object, and return its name. The MVPP completes this operation by converting the screen coordinate to a map coordinate and searching for the coordinate in the database of geometry. When found, the Map Server queries the geometry to obtain its name attribute, for example, which is then returned.

An example of a client request to publish and preview a map, shown in FIG. 6, relates common functionality of the Map Server, how it communicates with the Application Server via the Spatial Data Bridge, and how it interacts with the Database Server. The request occurs in two distinct stages; in the first, a map object is constructed for the published map, in the second, a view of the map is rendered and sent to the client for previewing.

In stage 1, the client sends a request to publish a map 88. The Application Server 90 handles and sends the request to the Spatial Data Bridge 92, which packages it for the Map Server 94. The Map Server decodes the request, obtains spatial and attribute information about the map from the Database Server 96, and publishes the map. The completion of stage 1 initiates stage 2.

In stage 2, the Application Server sends a request to render the map 98 via the Spatial Data Bridge 100, which packages it for the Map Server 102. The Map Server decodes the request and renders the map. The Map Server saves the rendering on the system 104, which the Application Server sends back to the client as the preview image 106.

Network-Centric Computing

MVPP uses a network-centric, thin-client computing approach to provide users shared access to central storage and resources on the system, and to efficiently divide the processing between an “empowered” client and a server. An empowered client implemented with, for example, Java or DHTML, enriches interactivity and takes responsibility for a portion of MVPP's functionality. It means less time spent waiting for the server to respond to user requests and provides many more options for client-based functionality, for example, the ability to resize maps and set map viewing areas.

Application Service Provider

The MVPP system is a hosted web-based environment for viewing, publishing, and provisioning maps and spatial graphics. It uses an Application Service Provider (ASP) model to offer these services to any party. The advantages of an ASP are:

1. Facilitation of ready-for-use, do-it-yourself systems for quickly and easily creating and providing secure and reliable applications to a wide audience.

2. Reduction of the information technology problem of system support and maintenance tasks and hiring, training, and retaining staff.

3. Guaranteed performance, reliability, and security via a well-defined Service Level Agreement.

4. Shared access, central control of server resources means software upgrades and functional enhancements are easy to manage and facilitates behind-the-scenes scaling of performance and storage capacity.

5. A service approach that is a low cost, hassle-free alternative to building, supporting, and maintaining similar solutions inhouse.

MVPP 108 (FIG. 7) leverages other ASPs for some system functionality, for example, Geocoding services 110 to find address locations and Routing services 112 to find the shortest distance/time paths.

Geocoding translates an address to a physical location on a map. There are various methods for implementing geocoding. One method applies address ranges to segments of a physical street; for example, segment 186 of Elm Street, in Butte, Mont., contains addresses 500-530. The location of 515 Elm Street, then, is interpolated to be at the midpoint of the segment. This method does not guarantee accuracy; 515 μm Street may in fact be closer to one of the endpoints, as addresses represent unequal physical areas.

Routing is a method for finding a path between two points, also known as nodes, on a network. In mapping systems, routing is often used to calculate street directions between two physical locations. Typically, the path representing the shortest distance between two addresses is desired, however, traffic patterns, which may affect the cost of traversing a segment, may also factor into the calculation.

The use of geocoding and routing services is transparent to the user 114 (FIG. 7), who is concerned only with the results, for example, where is 3 μm Street or what is the best way to get from my home to the Airport. By offloading these services to other ASPs, the MVPP system saves the time and expense of building, maintaining, and support them inhouse. It allows MVPP and its designers to focus on providing viewing, publishing, and provisioning services to users.

Uploading Data Sets

The user starts with data sets on their system and uploads them to the MVPP server. A data set contains information about spatial features and attributes, for example, a data set for U.S. Cities may include the geographic location of the city, its name, population, how it voted in the last election, etc.

The upload process provides the benefits of a do-it-yourself system, for example, the ability to upload data at any time of day, any number of times from the convenience of the desktop. A web-based interface provides ease-of-use with minimal training and shared access to information. MVPP seamlessly integrates the data into the system, providing immediate access to the data for use in published maps.

As seen in FIG. 8, data sets 116 are transferred over the network 1118 to a system directory 120 where they are queued for MVPP integration. A converter program 122 reads data sets from the queue and converts them to a common data format. The converted data is loaded into spatial data tables 124 describing, for example, spatial coordinates and attributes. Once in the spatial data tables, the data sets are available for map publishing.

Publishing Maps

The user defines and builds maps and spatial graphics on the system using a web-based system. The maps are comprised of separate data layers, for example, U.S. Highways, Parks, Cities, etc., which are based on the uploaded data sets. MVPP allows the user to define the text-based and visual attributes for the data layers, for example, the name of the layer is “Raleigh Streets”, use a solid line and the color black for streets, use a circle with a star in the middle for cities, etc. The visual attributes of a layer are comprised of layer elements, for example, for the “Ohio Counties” layer, use a polygon element to paint the county the color tan and place a black border around it, use a text element to label the county with its name. FIG. 9 shows the relationship between Data Sets 126, Maps 128, Layers 130, and Layer Elements 132.

MVPP allows users to categorize how web-based maps and map layers look using style definitions, which are saved descriptions (in XML, for example) that describe, for example, the composition and layout of maps, and the visual attributes of map layers. The ability to define a style one time, and apply it multiple times to maps and map layers enhances productivity, convenience, and ease-of-use. Styles can be shared across departments and organizations.

A map composition and layout style dictates what map accessories to include in the map layout, for example, a legend, a north arrow, a tile bar, etc., and how to layout the accessories, for example, place the legend on top of the map at the lower left corner. A map layer style dictates how to display layer elements, for example, use red for polygons and include a border, add text for the polygon's name and center it, etc.

Users are able to create map stylings to save and reuse map compositions and layouts and layer settings. The user loads and applies a map styling when creating and publishing new maps or as a default for all maps created within a group or organization.

Provisioning Maps

MVPP is a web-based system for provisioning maps to users based on a levels of security, for example, maps with a private level are available only to privileged users, maps with a public level are available to any user. MVPP defines different types of system users based on, for example, their ability to publish and provision maps and/or their ability to view and access maps. MVPP defines a publisher-to-viewer duality which enables a powerful system for the creation, organization, and control over web-based map publishing and provisioning and map viewing. For example, Map Publishers create maps from the data they upload and provision maps with levels of security granted to groups and their members. Map Viewers are the map-viewing audience, for example, a member of the public who wants to view a tourist map of San Francisco or a member of an organization who needs to view service calls by area.

User are not granted access to maps individually, rather, they are first assigned to groups. Groups are categories of users who share a need for a common set of maps, for example, Telecommunications Engineers who need call-quality and network maps of their service area. In this example, call-quality and network maps are assigned to the group “Telecom Engineering” consisting of members from the engineering team. The advantages of provisioning maps by group rather than by user are:

1) The improved efficiency in simultaneously managing an entire group of users vs. individual users.

2) The ability to organize and categorize users into functional areas based on map and spatial information needs.

3) The ability to define group-based levels of security for maps and spatial information.

FIG. 10 shows the relationship between users 134, groups 136, and maps 138.

Viewing Maps

Users in the MVPP system are able to view maps using an Interactive Viewer (IV). The IV is a powerful thin-client which provides navigation control over maps, for example, zoom-in to the area specified by a box dragged over the map, and querying control over maps, for example, find all parcels within a 500 foot radius of a point clicked on the map.

Managing Data Sets

With the Map Viewing, Publishing, and Provisioning (MVPP) application, the user is in charge of managing their own data. The user uploads and stores copies of data sets on the system, for example spatial data files describing street boundaries, new home locations, customer drop off points, etc., on a server. Once loaded into the system, the user edits data sets from the convenience of their desktop. The user can also update data sets or remove them from the system at any time using a web-based interface.

The user can store graphics, for example, a legal disclaimer and an identifying city seal graphic, on the system. The graphics can be placed on created maps. The graphics can be updated and deleted at anytime from the convenience of the desktop using a web-based interface.

Viewing Data Sets

The user views a list of stored data sets on a web page as shown in FIG. 11. Information about the data sets is displayed on the web page, for example the name of the data set, a description, last modified data, geometry type, census tracks, etc.

Adding Data Sets

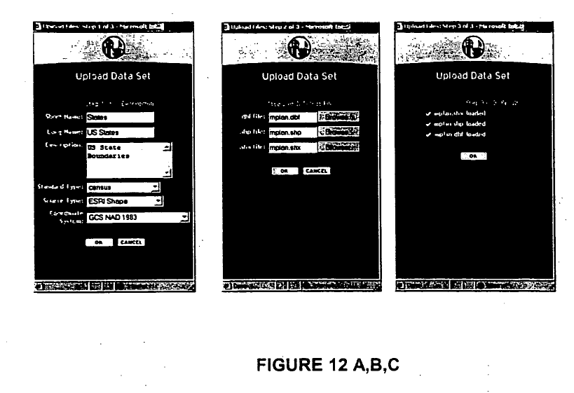

The user adds data sets to the system at any time using a web-based interface to upload the data set. The user is guided through a series of operations (FIG. 12A, B, C) to define the data, for example the data set format, the geometry type, etc., to select the data files to upload, for example, the files describing geometry points and data attributes, and to initiate the upload. The MVPP application begins the upload process and informs the user of the progress, for example, the percentage of upload completed. If an error is encountered, such as invalid data files, or an interruption of the upload process, the system informs the user with an error message.

Upon successful completion of the upload, the system informs the user of the success and lists the added data set on a web page. As an example, upon a successful upload, MVPP might display the message “Data set ‘State Boundaries’ has been successfully uploaded” and add a status indicator icon next to the listed data set denoting successful upload and file conversion. If an error has occurred, MVPP might display the message “Data set ‘State Boundaries’ is missing information. Please check the data and try again.”, and display an error status icon next to the listed data set. Other examples of errors are “Invalid format”, “Server Error”, “Process interrupted”, etc.

MVPP automatically stores the necessary information about the data in a database, for example, information on the geometry, spatial indexing, attribute information, and meta-data to describe the data set and its data fields. MVPP allows a user to add data sets at any time from the convenience of their desktop with a web-based interface. It automatically prepares data sets for publishing, provisioning, and viewing in maps and spatial displays.

Describing Data Sets

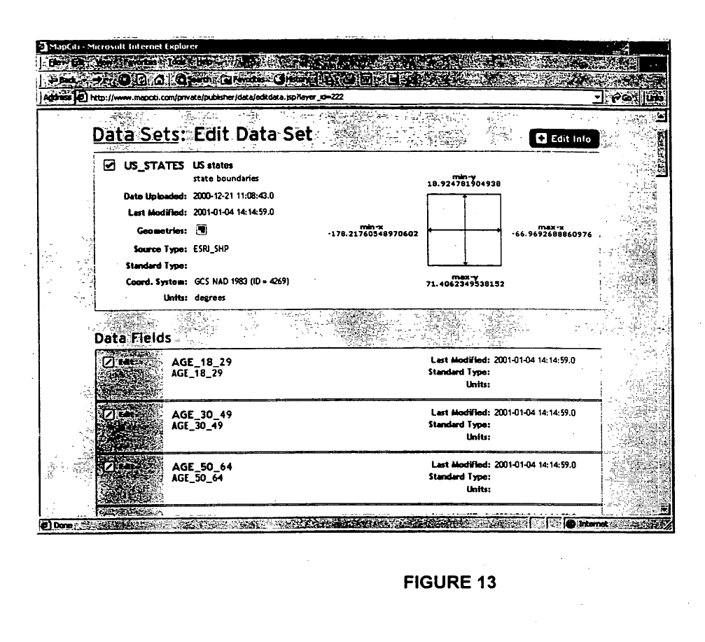

The user edits detailed information about data sets from the convenience of their desktop using a web-based interface (FIG. 13), for example, data set name, description, geometry type, source type, units, and coordinate system. MVPP displays the data set's spatial extent using a web graphic to denote, for example, boundaries and minimum and maximum points.

The user may also edit detailed information about data fields in the data set, for example, data field name, description, last modified date, and units.

Deleting Data Sets

The user deletes data sets on the system at any time using a web-based interface. The user selects the data sets for deletion and is asked to confirm the operation. MVPP automatically deletes the data set and performs the necessary backend system operations to delete the data.

Managing Maps

With the MVPP application, the user is in charge of creating maps based on their data. The first step is to upload and store the data on the server. Next, the user decides how to display the data. The user is able to create a collection of maps and make frequent updates easily and efficiently to offer the latest information. Users are able to delete maps at any time.

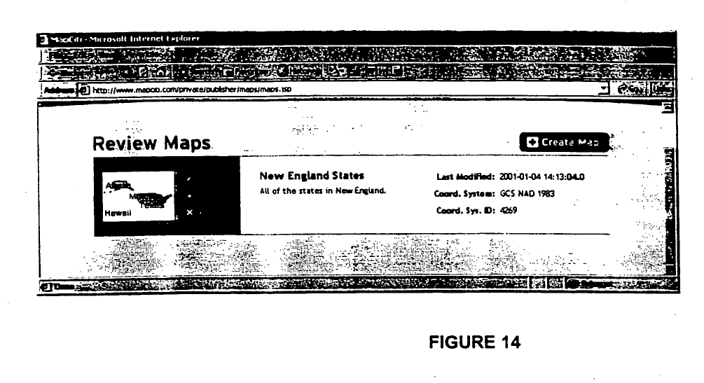

The user views a list of stored maps on a web page (FIG. 14). Information about the maps is displayed on the web page, for example the name of the map, a description, last modified date, coordinate system, etc. MVPP displays a preview image of the map on a web page. The user is able to open a map in the MVPP Interactive Viewer (IV) by, for example, clicking on the preview image or on a preview icon. In the IV, the user is able to perform navigational functions on the map, for example, “Zoom-in”, “Zoom-out”, “Pan”, “Zoom-to-extent”, and to use the map as a context for informational functions, for example, to describe a map feature at a point (X,Y), locate and zoom-to Tower 1, display all the Homes that sold in the last year, locate and zoom-to an address, etc.

Creating Maps

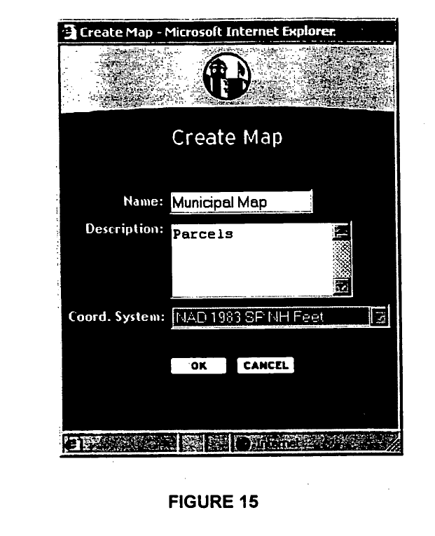

The user creates a map using a web-based interface (FIG. 15) to specify the attributes of a map, for example, the name, description, coordinate system, etc. MVPP displays the name and description wherever the map is listed and displayed. A map is composed of spatial features and attribute information, for example, “Streets”, “Households with Children”, etc., which are defined with data sets and displayed with map layers. Map layers contain map layer elements to define styling and symbology for the spatial features; for example, a street is described with a black line and a label along the top.

To exemplify map creation, imagine a user who wants to create a map of their town showing streets, highways, parcels, and points of interest. The user obtains the data (for streets, highways, etc.) and uploads it to the system. The user creates a map called “My Town” and assigns the street data to a new layer called “Streets”. The user wants streets to appear as black lines with the name of the street on top. Two layer elements are created; one is a black line element for the street, the other, a label element for the street name along the top. The user repeats these steps for highways, parcels, and points of interest.

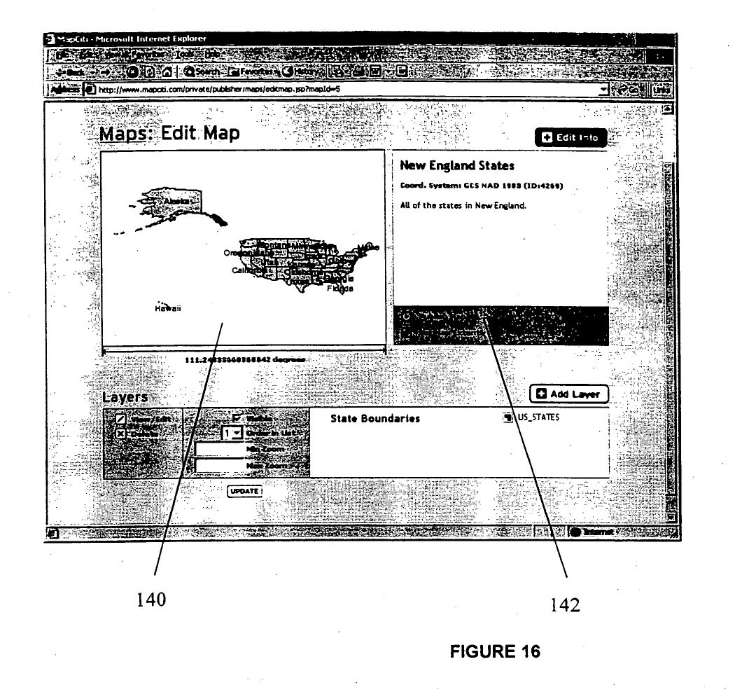

The user edits maps using a convenient web-based interface (FIG. 16) to modify attributes, for example, map name and description.

MVPP displays an image to preview 140 (FIG. 16) a map over-the-web which allows the user to visualize the overall design and structure of the map before provisioning the map to viewers.>

MVPP allows the user to create map bookmarks, which incorporate a preview image of the map, styles, and parameters, to open the map in the IV from any web-enabled system.

Map Publishing

The user performs modifications on a map and, when finished, is responsible for republishing the map to commit and view the changes. With MVPP, A user is able to publish a map over-the-web by, for example, clicking a button 142 (FIG. 16) to initiate the publishing process on the system. Publishing is the last stage in the process after the definition of styling and composition and is explicitly initiated by the user. Publishing is explicitly initiated because it is an expensive system operation. Its automation would place an unnecessary load on the system because, since it is never known when the user has completed modifications, it would have to occur often to assure the user is viewing the most up-to-date map.

Defining the Initial Map Extent

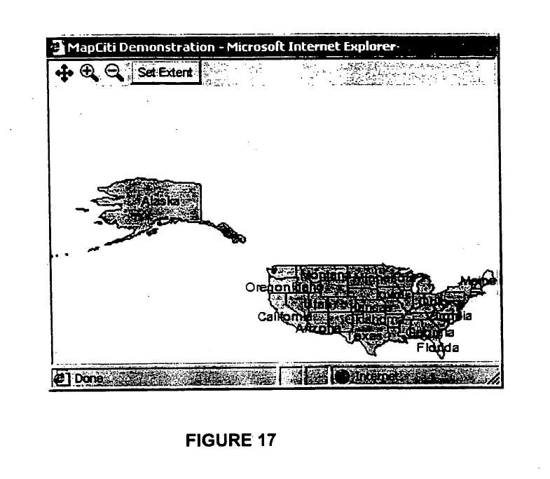

The user is able to define the initial map extent using a web-based interface (FIG. 17). The initial map extent defines the map view to display when first loaded in the IV. The initial extent is often an overview of the entire map; for example, a map of the 49 contiguous U.S. states would show all 49 states in the initial extent. In some instances, however, a subsection of the map is of primary interest. MVPP allows the user to define the initial map extent in the IV with navigational controls, for example, “Zoom-in”, “Zoom-out”, “Pan”, and “Zoom-to-box”, “Resize”, etc. MVPP automatically saves the initial extent parameters and uses them whenever the map is first displayed.

Deleting Maps

The user deletes maps on the system at any time using a web-based interface. The user selects the map for deletion and is asked to confirm the operation. MVPP automatically deletes the map and performs the necessary backend system operations to delete the data.

Adding Layers

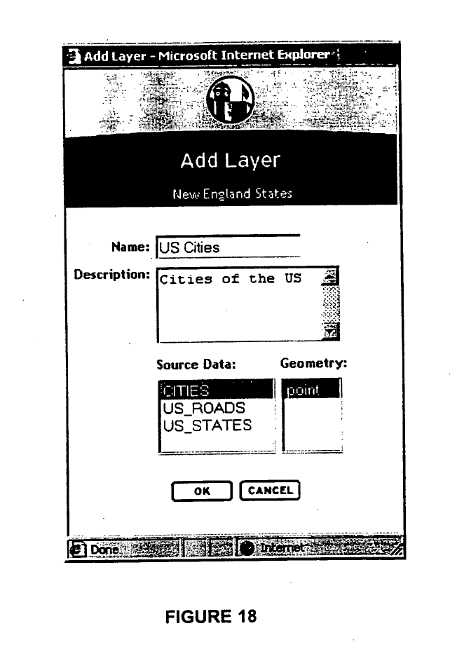

The user defines the spatial features of a map with a combination of layers based on data sets. The user adds a layer using a web-based interface (FIG. 18) to select a previously loaded data set to represent the layer and to define layer attributes, for example, the layer name, description, and geometry type.

The user views a list of defined layers for the map on a web page. Information about the layers is displayed on the web page, for example the name of the layer, a description, and the geometry type. An icon is used to represent the type of geometry used for the layer, for example, point, line, polygon, etc. Using a web-based interface, MVPP allows the user to turn a layer's visibility on or off in the map and to set the drawing and display order relative to other map layers. For example, if the layer's order number is “1”, MVPP will draw the layer last and on top of other layers. It is important to set the drawing order so that polygon layers, for example, don't obscure line and text layers.

Describing Layers

The user first defines the layer and its text-based attributes, for example, layer name and description. Next, the user assigns a set of spatial layer elements to the layer, for example, one layer element to describe the layer's geometry, another its labeling. Styling and symbology are defined for layer elements; for example, use white, solid-filled polygons to represent U.S. States or a black circle with a star in the center to indicate the location of a city. Layer elements may also be themed according to the numeric or categorical value of one of the layer's attributes. For example, use the color blue for State Counties that voted Democratic in the last presidential election or use the color red for districts where the ratio of low birth weight babies is over 7/1000.

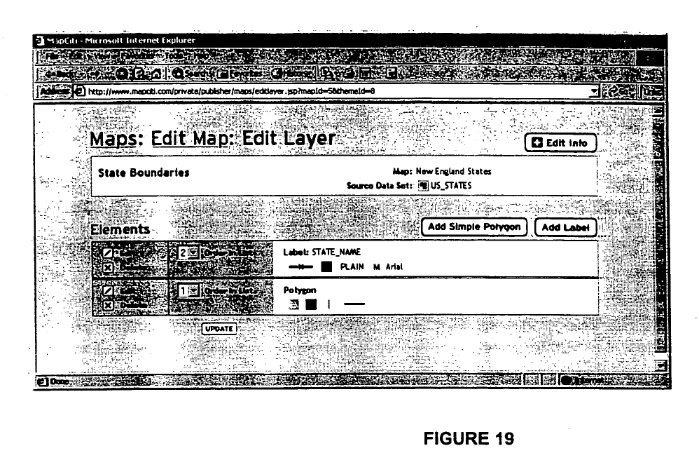

The user edits layers with a web-based interface (FIG. 19) to modify, for example, layer name, description, and the layer elements.

Adding Layer Elements

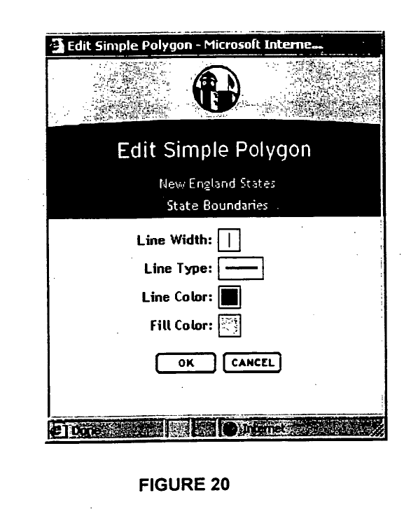

With a web-based interface (FIG. 20), the user defines the visual attributes, for example styling and symbology, of a layer with layer elements to represent, for example, the layer's geometry and labeling based on data attributes. The type of layer element may be, for example, a line, polygon, point, or text. The user adds a layer element with a web-based interface to define, for example, the layer element's line width, type, and color or the layer element's font, data field, size, etc.

The user views a list of defined layer elements (FIG. 19) for a layer on a web page. Information about the layer element is displayed on the web page, for example, the layer element's polygon color, fill type, etc. Any number of layer elements is used to portray a layer. For example, a “Walking Paths” layer may use a thin, black, dotted line layer element to portray the walking path, a black, 10 point, Verdana font text layer element to portray walking path name, and a blue, 10 point, Arial font text layer element to portray walking path length.

Using a web-based interface, MVPP allows the user to set the drawing order of a layer element relative to other layer elements in the layer. For example, if a text layer element's order number is “1” and a polygon layer element's order number is “2”, the text with be drawn on top of the polygon for the layer. This is important for a “Lakes” layer, for example, where the name of the lake must appear on top of the polygon of the lake.

Describing Layer Elements

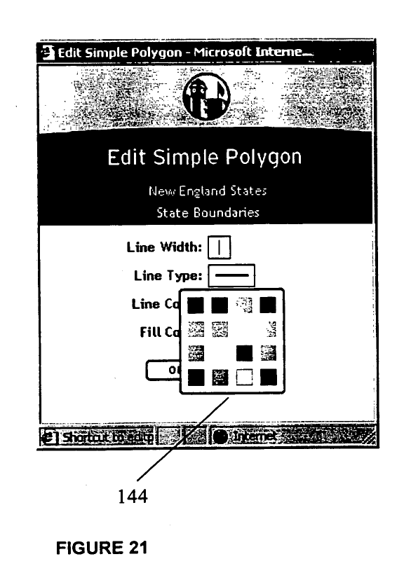

MVPP allows the user to define the visual attributes of a layer with a variety of layer elements, for example, lines, polygons, points, and text. A web-based interface is used to specify a layer element's properties, for example, a point's marker type, size, and color. MVPP uses pop-up windows (FIG. 21) 144 to show a palette of selections the user may select from for a given layer element property, for example, line type. This web-based method for selecting from a palette of choices is very convenient, easy-to-use, and allows MVPP designers to add choices to the palette and continually expand selection.

Describing Line Layer Elements

The user defines line layer elements with a web-based interface. MVPP displays a pop-up window showing the palette of selections for the given line property, for example, line color, width, and type. As the cursor is moved across the palette, the selection is highlighted. Once the selection is made, the pop-up window is closed and the web page portrays the selected value.

Describing Polygon Layer Elements

The user defines polygon layer elements with a web-based interface. MVPP displays a pop-up window showing the palette of selections for the given polygon property, for example, polygon line width, color, type, and fill color. As the cursor is moved across the palette, the selection is highlighted. Once the selection is made, the pop-up window is closed and the web page portrays the selected value.

Describing Point Layer Elements

The user defines point layer elements with a web-based interface. MVPP displays a pop-up window showing the palette of selections for the given point property, for example, point marker, size, and color. As the cursor is moved across the palette, the selection is highlighted. Once the selection is made, the pop-up window is closed and the web page portrays the selected value.

Describing Text Layer Elements

The user defines text layer elements with a web-based interface.

MVPP displays a pop-up window showing the palette of selections for the given text property, for example, font, data field, size, color, style, and alignment. As the cursor is moved across the palette, the selection is highlighted. Once the selection is made, the pop-up window is closed and the web page portrays the selected value.

Deleting Layer Elements

The user deletes layer elements using a web-based interface. The user selects the layer element for deletion and is asked to confirm the operation. MVPP automatically deletes the layer element and performs the necessary backend system operations to delete the data.

The MVPP Interactive Viewer

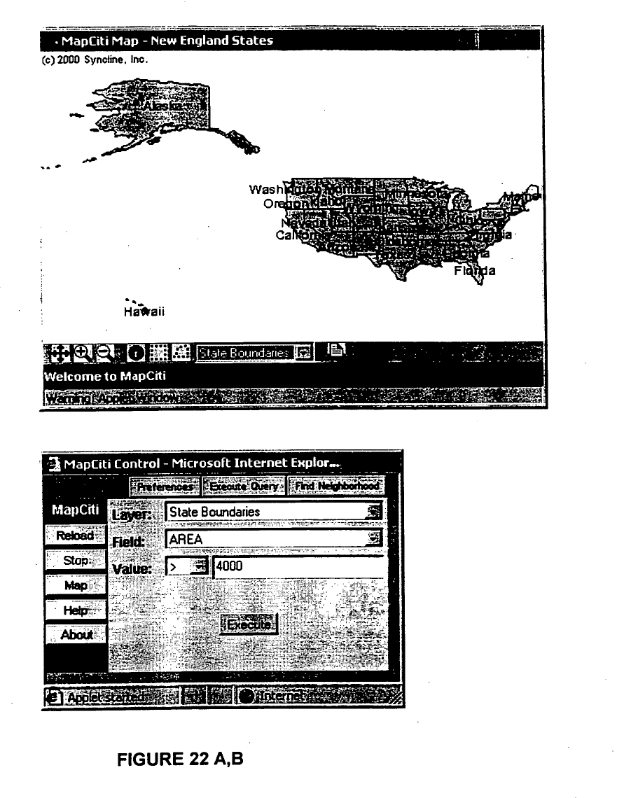

The MVPP Interactive Viewer (IV) (FIG. 22A, B) defines a rich set of map navigation and query controls that allow users to precisely set the portion of the map for viewing and to obtain information on spatial features. For example, the user may be interested in finding video stores within a certain zip code in the city of Boston. In the IV, MVPP displays a map of the city of Boston, and the user zooms to a view that displays the zip code in its entirety. Next, with a web-based interface, the user queries MVPP to find all the video stores within the current map view. MVPP returns with a listing of the video stores and marks their locations on the map. The user may select one of the video stores to zoom to its location on the map and obtain more detailed information. Alternatively, if the user knows the name of a particular video store, they can enter it in a query field to zoom to its location on the map.

The user clicks on a map feature in the IV to identify and obtain more detailed information on the feature. For example, they may click on a building to list its name, owner, address, occupants, etc.

The user may click on the map to place a marker at some location, for example, a proposed location for a new stop sign at a street intersection. The user may associate information with the marker, for example, the description “Proposed location for requested stop sign at Baker St. and 1st.”

The user is able to find the distance between two points or along a multi-segmented line path on the map. The user clicks on the map to define the first point. MVPP displays the length of the line as it is dragged until the user clicks on the second point. This is continued with subsequent points and line segments until the user exits the operation. Alternatively, the user uses a web-based interface to enter two distinct map locations and prompts the system to calculate the distance between them.

MVPP is capable of computing the shortest distance between two points along a multi-segmented, networked path. This is an important feature that allows users to, for example, determine the shortest distance/time path (which may depend on traffic patterns) between a customer's location and a service truck in the field.

MVPP can use an external ASP providing routing services to determine shortest distance/time paths. By offloading the routing service, the MVPP system saves the time and expense of building, maintaining, and supporting Routing inhouse. MVPP can focus on its main purpose; to provide viewing, publishing, and provisioning services to users.

MVPP uses an external ASP providing Geocoding services to find address locations. MVPP queries the Geocoding service to find a specific address and the Geocoding service responds with (X, Y) location. By offloading the geocoding service, the MVPP system saves the time and expense of building, maintaining, and supporting Geocoding inhouse. MVPP can focus on its main purpose; to provide viewing, publishing, and provisioning services to users.

Map Provisioning

MVPP defines Users and Groups to allow map publishers to provide secure access to maps over the web. A User is any individual who views maps. A Group is a set of Users who share common needs for map and spatial information. An example of a User is “John Smith”, a citizen of Sharon, Mass. An example of a Group is “Citizens of Sharon, Mass.”. The Users “John Smith”, “James Brown”, etc. who are citizens of Sharon are members of the Group “Citizens of Sharon, Mass.”.

Once Users and Groups are defined and Users are assigned to Groups, map publishers assign Maps to Groups to grant Users in the Group access to the Maps. For example, in the previous example, the Town of Sharon may sponsor a referendum to purchase a 400-acre tract of land to prevent its development. The Town is interested in preserving open space inside its borders and is concerned about the increased tax burden placed on citizens to support new services and infrastructure for development on the land. It wants to publish maps of the affected area with detailed information about the points of interest, history, size, location, etc. along with examples of how development will increase taxes. The Town hopes to convince citizens of the importance of preserving the land and to alert them about tax increases. Using MVPP, the Town's map publisher creates maps representing the town before and after development, showing a few different scenarios for the latter and the associated costs for services and infrastructure to support the development. The map publisher also creates maps portraying the results of a private ground water and drainage study paid for by the town to ascertain the environmental impact development could have on nearby residents and water resources. The town wants to share the first set of maps with all citizens; however, the second set contains sensitive information for internal use only. The map publisher creates the group “Citizens of Sharon” and adds the before and after maps to the group. Public access is granted to the group to allow all users to view the maps. For the second set of maps, the group “Purchase Committee” is created and the sensitive maps added. Private access is granted to the group to allow only Purchase Committee members to view the maps.

Provisioning Map Layers and Map Layer Attributes

MVPP allows information at the map layer and map layer attribute level to also be provisioned in a secure manner, much the same way maps are provisioned to users at the group level.

Provisioning layers allows map publishers to define which users and groups are able to access layers (the data in the layer). For example, a conversation agency may own large plots of land, some of which it maintains for public recreational usage with hiking trails and instructional beacons, and some of which it protects for wildlife habitat usage. The agency creates a map containing layers for the public and protected lands. The public land layer is viewable by all MVPP users; the protected land layer, however, is provisioned so that only internal agency staff can view it.

Map layer attributes that contain “sensitive” or yet-to-be-validated information may need to be protected. The attribute could be provisioned so that only users who are in the validation process can view it. When ready, the attribute is made widely available.

Managing Groups

In MVPP, Map Publishers are users who create maps, create groups, assign maps to groups, and assign users to groups. All the users in a group are granted access to maps in the groups. Map Viewers are users who view maps. Map Publishers make it easier for Map Viewers to view maps by grouping maps together by category. For example, map publishers can create a “Land Developers” group that includes maps showing land use, parcel information, sewer lines, and tax assessment records. Another example is a “Parents of school-age children” group that includes maps showing school districts and bus routes.

With MVPP, the user is in charge of granting access to maps they create. Groups in MVPP are assigned a level of security. For example, Private Groups are those that allow only users that are members of the group to access maps in the group. Public Groups allow any named user logged into MVPP to access a map in the group. Anonymous Groups allow any web user to access a map in the group. In this example, Private Groups are the most secure; the map publisher must explicitly add a user to the group for the user to access a map in the group. Anonymous Groups have no security. They allow any web user to access a map in the group. Map Publishers restrict access to maps with “sensitive” information using Private Groups. Alternatively, maps are made generally available using Anonymous Groups.

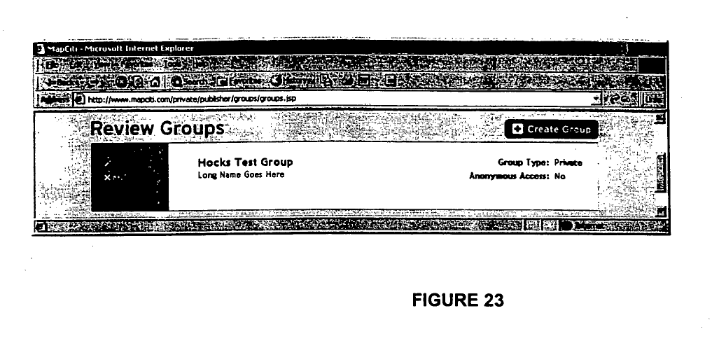

The user views a list of stored groups on a web page (FIG. 23). Information about the group is displayed on the web page, for example, the name of the group, a description, last modified date, group access level, etc.

Creating Groups

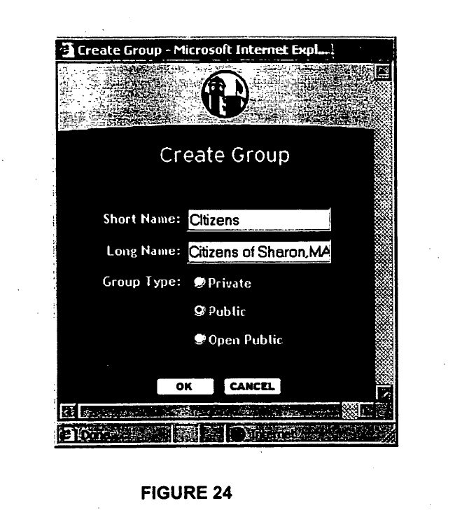

The map publisher creates a group using a web-based interface (FIG. 24) to specify the attributes of a group, for example, the name, description, group access level, etc. Once the group is defined, the map publisher assigns maps and users to the group.

The user edits group with the convenience of a web-based interface to modify attributes, for example, group name and description.

Describing Groups

The map publisher first defines the group; its name, description, and access level. Next, the map publisher selects maps to include in the group from a web page listing previously defined maps. Maps can also be removed from the group by selecting the map and removing it. The map publisher selects users to include in the group from a web page listing previously defined users. MVPP allows map publishers to search the database of users for, for example, special characters to return only those users matching the search criteria. Users can also be removed from the group.

MVPP defines group access levels to control and restrict access to secure information. For example, Private Groups grant access to only users who are members of the group. Public Groups grant access to any user logged into MVPP. Anonymous Groups grant access to any web user.

Administrative Control

MVPP allows users with administrative privileges to control user/group access to system functionality, for example, geocoding and routing, and map oriented behavior, for example, the ability to view a map, restrict access by map scale, restrict access to map layers and layer elements, etc. Administration is controlled with the convenience of a web-based interface.

Thematic Maps

MVPP allows users to define the theming of map and spatial information using a web-based interface. Theming uses visual cues, for example, colors, patterns, or symbols, to distinguish displayed information by value, value range, or category. It is an effective way to visually encode information in maps and spatial displays.

As an example, imagine a user wants to distinguish whether a U.S. State County voted Democratic or Republican in the last presidential election. First, they create a polygon layer element to represent the counties. Next, the user creates a theme based on the layer data field “Party” representing whether the country voted Democratic or Republican. The user indicates to display the color blue where Party equals “Democratic”, and red where Party equals “Republican”.

Image Data

MVPP allows users to incorporate image data into maps using a web-based interface. Image data is raster information representing, for example, pictures of the earth taken from space or an engineering blueprint of a building. Each pixel in the image encodes a gray-scale or color value for a point in the image. Image data provides a real-world context for maps, especially when combined with other map features.

As an example, imagine a user wants to create a map of a state park. They have a satellite photograph of the park and on top want to overlay park roads, hiking paths, and points of interest. The user first creates a map of the park showing roads, hiking paths, and points of interest. Next, they upload information representing, for example, the image of the park and the spatial locations of the image's four corners. The image data is combined with the other features to create the final map.

Printing

MVPP allows users to create hardcopy outputs of electronic maps using a web-based interface. A web-based interface is used to setup hardcopy attributes, for example, how to scale the map to fit a 14×″×11″ sheet of paper, leaving space for a map legend on the lower left, a north arrow, and a map scale. The user can add a title to appear across the top border of the map, the map author, the print date, revision, etc.

Printing is a powerful way to view maps in the field and to create, for example, large-sized wall hangings. MVPP allows a map viewer to request, for example, a 11″×17″ hard copy of a map displaying streets, parcels, contours, land use, and buildings, a north arrow, an accompanying overview map, a key grid, and a publishing date. As another example, the system might be used to create high-quality hardcopies, which are then mailed or stored for pickup.

Map Accessories

Using a web-based interface, MVPP allows the user to define and include map accessory information, for example, a map legend showing the styling and symbology used for map layers, a map north arrow showing the true north direction, a map scale, and an overview map showing either an index of maps or a larger view of surrounding areas. Accessories may be placed adjacent to or on top of the map.

Map legends further describe layers displayed on the map. They often contain a name for the layer, and the symbol used to display the layer. For example, the map layer “U.S. States” is shown with the legend label “U.S. States” and a square icon symbolizing the style (color, line thickness, etc.) used to draw states. The map legend may also portray the order used to draw map layers, useful for showing how information is overlaid.

Theming is often portrayed in the map legend. For example, cities may be themed by population, showing larger, more prominent symbols for high population cities, and smaller symbols for low population cities. The legend displays all the theme categories, showing, from top to bottom, the symbol and population range for the highest population cities, followed by the next highest category, and so on.

Map north arrows are useful for showing the orientation of a map. The north direction for a given map is calculated, and a user-selected symbol depicting and oriented north is placed on the map. Alternatively, the user may want to depict other directions, for example, South, East, West, South-South East, etc.

Map scales depict the ratio between distances represented on the map and the real world. For example, if one inch on the map corresponds to 100 feet in the real world, the map scale is 1:1200. The scale provides a real-world sense for the area covered in the map. For example, the scale 1:12,000,000 corresponds to area encompassing all of Europe (on most computer screens).

Overview maps are often used to provide a reference to the greater surrounding area for the map view. The center point or extent of a zoomed map view is depicted in the overview map. Overview maps are also used as key maps for other maps. For example, the overview map might depict sections of a Power Utility's coverage area. Clicking on a section brings up a map of the section in the main map window.

Map and Map Accessory Layout

A web-based interface allows the user to control the layout of the map and accessory information using, for example, an interface layout panel where the user drags and positions components. The layout panel represents how maps and the accessory information will be displayed in the IV and when printing, for example, where to place the overview map, the legend, the tile bar, etc.

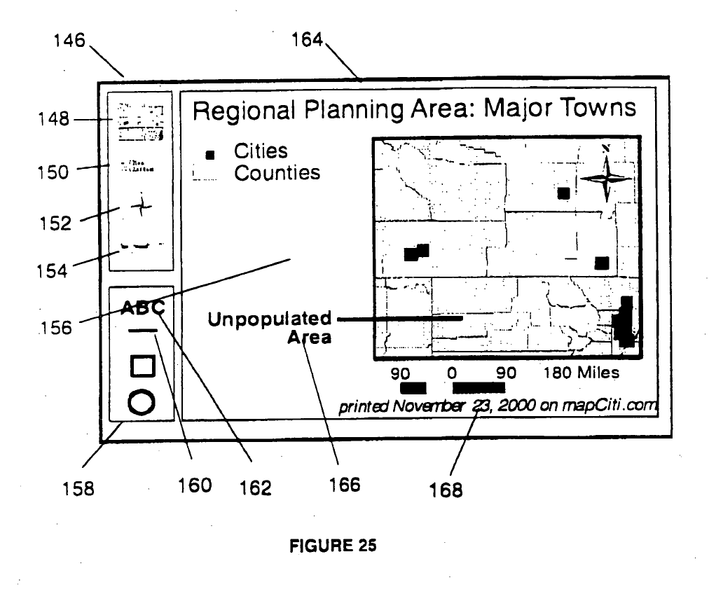

FIG. 25 is an example of an interface to control and view map and map accessory layout. On the left, a box 146 containing items for the map 148, legend 150, north arrow 152, and scale 154 are listed. The user selects the items, drags them into the composition area 156, and sizes them to the desired dimensions. A drawing box 158 lists text 160, line 162 and other objects which are also selected, dragged, and sized into the composition area. The user is able to create a title bar 164, notes 166, and other information 168.

Other implementations are within the scope of the following claims.

1. A method comprising
at a web server, providing web-based map viewing, publishing, and provisioning services, and
centrally storing map information for use in providing the services.

2. The method of claim 1 also including
receiving from an application server or a mapping server requests associated with the viewing, provisioning, or publishing of maps, and
providing a bridging function that includes reformatting the requests into non-proprietary standardized formats.

3. The method of claim 1 also including
storing the map information in a database,
abstracting the map information to generate metadata that represents the information, and
enabling a mapping application to access the metadata.

4. The method of claim 1 also including
receiving requests that relate to viewing, publishing, or provisioning web-based maps, and
serving the requests at least in part by accessing remote application service provider functions.

5. The method of claim 4 in which the functions include locating addresses or finding shortest paths.

6. The method of claim 1 also including
enabling a user to upload map data from a client through the Internet to the server for use in executing the publishing and provisioning services.

7. The method of claim 6 in which the uploaded map data is automatically integrated with the stored map information for access by remote viewers.

8. The method of claim 1 also including
enabling a user at a web-client to define and build maps and spatial graphics by interaction with the server.

9. The method of claim 1 also including
enabling users to categorize how web-based maps and map layers will appear based on style definitions.

10. The method of claim 1 also including
enforcing levels of security to control access by users to the viewing, publishing, and provisioning services.

11. The method of claim 1 also including
managing access by users to the viewing, publishing, and provisioning services by grouping the users according to their rights to use the respective services.

12. The method of claim 6 also including
guiding the user interactively to define the data sets, select the data files to upload, and initiate the upload.

13. The method of claim 1 also including
enabling a user at a client to preview a map over-the-web prior to provisioning the map.

14. The method of claim 1 also including
enabling a user at a client to publish a map by a single mouse click to initiate publishing at the server.

15. The method of claim 1 also including
enabling a user at a client to define an initial map extent using a web-based interface.

16. The method of claim 1 also including
enabling a user at a client to define visual attributes of a layer.

17. The method of claim 16 also including
providing the user a palette of selections for a layer element property.

18. The method of claim 1 also including
enabling a user at a client to define theming of map and spatial information using a web-based interface.

19. The method of claim 1 also including
enabling a user at a client to incorporate image data into maps using a web-based interface.

20. The method of claim 1 also including
enabling a user to print electronic maps using a web-based interface.

21. The method of claim 1 also including
enabling a user at a client to define and include map accessory information.

22. The method of claim 1 also including
enabling a user at a client to control the layout of a map and accessory information using an interface layout panel that enables dragging and positioning of components.
